(19) United States
(12) Patent Application Publication
(10) Pub. No.: US 2008/0047123 A1
(43) Pub. Date: Feb. 28, 2008

(54) Method for producing self-attaching fasteners, a self-attaching fastener forming assembly, and a self-attaching fastener

(76) Inventor: Bill Whitaker, Addison, MI (US)

Correspondence Address: John G. Chupa;Law Offices of John Chupa and Associates, P.C., Suite 50, 28535 Orchard Lake Rd., Farmington Hills, MI, 48334, US

(21) Appl. No.: 11/503,328

(22) Filed: Aug. 11, 2006

(51) Int. Cl. B23P 11/00; B23P 17/00

(52) U.S. Cl. 29/428; 29/412; 29/700; 411/172

(57) ABSTRACT

A self-attaching fastener production system 10 in which pre-fasteners 22 are created and coupled together by wires 87, 88 before, in one non-limiting embodiment, they are respectively communicated to a tapping portion 50 in order to form self-attaching fasteners.

### GENERAL BACKGROUND

1. Field of the Invention

The present invention generally relates to self attaching fasteners and more particularly to a new and novel method for producing self-attaching fasteners which may include a new and novel self-attaching fastener forming assembly, wherein the new and novel method produces self-attaching fasteners in an efficient and accurate manner and wherein the present invention also relates to a new and novel self-attaching fasteners.

2. Background of the Invention

Self-attaching fasteners are used in a wide variety of applications, such as by way of example and without limitation, within the automotive industry, and are adapted to be selectively joined or coupled to a panel or other sort of tangible entity.

Typically, such fasteners include a generally central projecting pilot portion which may be threaded, and at least one flange portion. The centrally projecting pilot portion is typically inserted thorough a tangible entity, such as a panel, either directly or thorough a pre-existing opening which is formed in the tangible entity. The at least one flange portion is typically adapted to receive some portion of the tangible entity which becomes deformed as a result of the insertion of the self-attaching fastener, thereby promoting the attachment of the fastener into the tangible entity and performing an “anti-rotation” function.

While such prior and current fasteners are adapted to be operatively inserted within a tangible entity and do provide an “attaching” or “securing” function, the process for manufacturing such self-attaching fasteners is inefficient and/or prone to error and the produced fasteners are not adapted to be readily/efficiently usable.

One non-limiting example of such errant fastener creation lies in the creation of fasteners having their respective pilot portions being “off center” or having their respective centers being positioned/located along an axis other than the axes which respectively and orthogonally pass through the center of these fasteners. Such errant pilot positioning causes these created fasteners to malfunction and/or to be errantly installed (e.g., a “die button” which may be utilized for the installation of these self-attaching fasteners does not correctly “line up” with the created pilot portions). Moreover, these pilot portions are often tapped by the use of a thread forming or tapping assembly and such “off center” variances, with respect to the pilot portion of these produced fasteners, often causes damage to the tapping assembly, destruction of the produced fasteners and/or errantly produced fasteners.

There is therefore a need for a new and improved method for producing self-attaching fasteners and for self-attaching fasteners which are produced by a new and novel method. The present inventions address these and other needs and, by way of example and without limitation, allows the fasteners to be selectively threaded in an efficient and accurate manner and which allows self-attaching fasteners to be efficiently and accurately produced.

### SUMMARY OF THE INVENTION

It is a first non-limiting object of the present invention to provide a method for producing a self-attaching fastener which overcomes some or all of the previously delineated drawbacks of current self-attaching fastener production methodologies.

It is a second non-limiting object of the present invention to provide a method for producing self-attaching fasteners which overcome some or all of the previously delineated drawbacks of current self-attaching fastener production methodologies and which, by way of example and without limitation, are placed upon a frangible wire.

It is a third non-limiting object of the present invention to provide a method for producing self-attaching fasteners which overcomes some or all of the previously delineated self-attaching fastener production methodologies and which produces new and novel fasteners in a new and novel manner.

It is a fourth non-limiting object of the present invention to provide a self-attaching fastener formation assembly which may be used within a new and novel self-attaching fastener production process.

It is a fifth non-limiting object of the present invention to provide a self-attaching fastener assembly which may allow fasteners to be easily and efficiently and selectively deployed in a desired manner.

According to a first non-limiting aspect of the present invention, a method for producing self-attaching fasteners is provided and includes the steps of obtaining wire; forming the wire into a plurality of discrete items, wherein each of the plurality of discrete items have a predetermined shape and with at least one groove; only after each of said plurality of discrete items have been formed, forcing a wire into each of the at least one grooves of each of the plurality of discrete items, thereby coupling the previously formed plurality of discrete items; and tapping each of the coupled plurality of discrete items thereby forming self-attaching fasteners.

According to a second non-limiting aspect of the present invention, a self-attaching fasteners forming assembly is provided and includes a straightener which receives and straightens wire; a die which receives the straightened wire from the straightener and which forms the received straightened wire into a plurality of discrete tangible items; a knurling assembly which receives the plurality of previously formed plurality of discrete items and which receives a second wire, wherein the knurling assembly couples each of the previously formed plurality of discrete items onto the second wire; and a taper assembly which receives the coupled discrete items from the knurling assembly and which produces a threaded hole into each of the received and coupled plurality of discrete items, thereby forming the self-attaching fasteners.

According to a third non-limiting aspect of the present invention, a self-attaching fastener is provided and is formed by the process of obtaining wire; producing a pre-self-attaching fasteners item by use of the wire; coupling the formed pre-self-attaching fastener to a wire; and forming a threaded hole within the coupled and formed pre-self-attaching fasteners, thereby forming a self-attaching fastener assembly.

According to a fourth non-limiting aspect of the present invention a fastener assembly is provided and includes the steps of forming a first pre-fastener; forming a second pre-fastener; placing previously formed first and second pre-fasteners on a wire; and tapping said previously coupled first and second pre-fastener, thereby forming a fastener assembly.

According to a fifth non-limiting aspect of the present invention a method for making a self attaching fastener is provided and includes the steps of obtaining a press fix nut; creating at least one wire retention groove within the obtained press fix nut; and placing wire within the created at least one wire retention groove, thereby forming a self attaching fastener.

These and other features, aspects, and advantages of the present inventions will be understood best by a reading of the following detailed description of the preferred embodiment of the invention, including the subjoined claims, and by reference to the included drawings.

### BRIEF DESCRIPTION OF THE DRAWINGS

FIG. 1 is block diagram of a self-attaching fastener production process which is made in accordance with the teachings of the various non-limiting and independent embodiments of the inventions.

FIG. 2 is a diagrammatic view of some of the pre-self-attaching fastener items which emanate from the applicator portion of the self-attaching fastener production process which is shown in FIG. 1.

FIG. 3 is a diagrammatic view of some of the pre-self-attaching fastener items which emanate from the press portion of the self-attaching fastener production process which is shown in FIG. 1.

FIG. 4 is a diagrammatic view of self-attaching fasteners which are made in accordance with the teachings of some of the various embodiments of the invention.

FIG. 5 is a block diagram of the applicator which is shown in FIG. 1.

FIG. 6 is a side sectional view of one non-limiting example of a self attaching fastener entity which is formed by one or more of the present inventions.

FIG. 7 is a partial exploded side view of a portion of the applicator which is shown in FIG. 5.

FIG. 8 is a side view of the wheel portion of the applicator which is generally shown in FIG. 5 but made in accordance with the teachings of an alternate embodiment of the invention and which therefore differs from the wheel which is shown in FIG. 7.

### DETAILED DESCRIPTION OF THE PREFERRED EMBODIMENT OF THE INVENTION

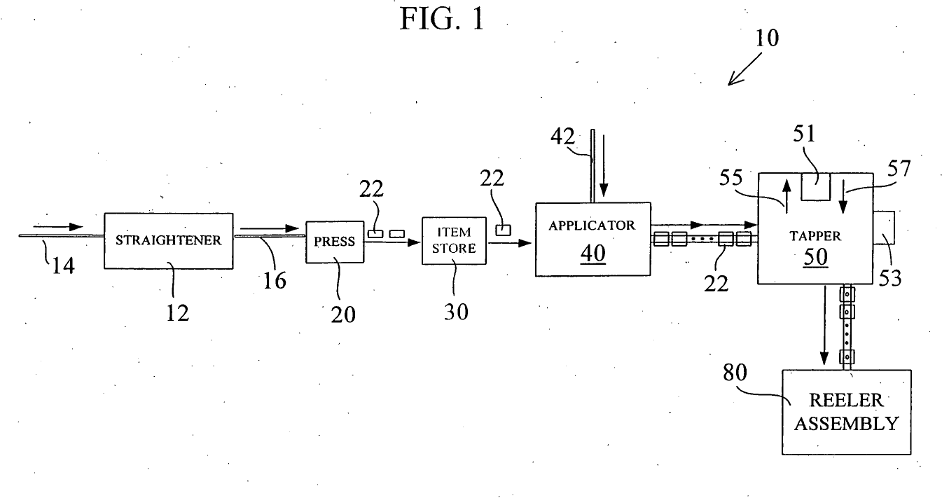

Referring now to FIG. 1, there is shown a self-attaching fastener production process or assembly 10 which is made in accordance with the teachings of the various embodiments of the invention. It should be appreciated that the term “system”, as used in this description, refers to both a process and/or to an assembly and to the various processes and systems which cooperatively constitute the various inventions set forth within this Application. Thus, the term “system” should be broadly construed as meaning a collection of tangible items which cooperatively form self-attaching fasteners.

Particularly, the system 10 includes a wire straightener 12 which receives wire 14 (e.g., commercially available steel type wire) and which selectively straightens and outputs straightened wire 16. In one non-limiting embodiment of the invention, the straightener 12 continually receives wire 14 and continually outputs straightened wire 16 as the process associated with the system 10 proceeds. In another non-limiting embodiment, the use of the straightener 12 is obviated and the obtained/received wire 14 is directly input to a press, such as press 20 which is described below. Thus, the straightener 12 is not required for all embodiments of the system 10.

The system 10 further includes a press 20, such as that produced and obtainable from The Minser Company of Hartford, Conn., which receives the straightened wire 16 and which produces “pre-self-attaching fastener” items or entities 22. It should be appreciated that the terms “pre-item” and “pre-self-attaching fastener” each refer to an item which is made in accordance with the inventions and which is to be tapped and to subsequently function as a self-attaching fastener or these term each refer to the tangible entities which respectively emanate from the press 20.

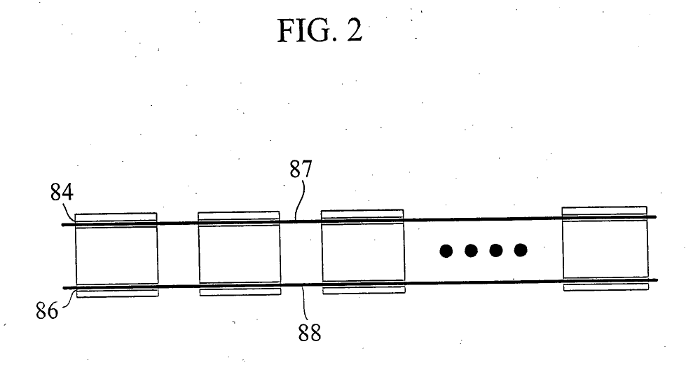

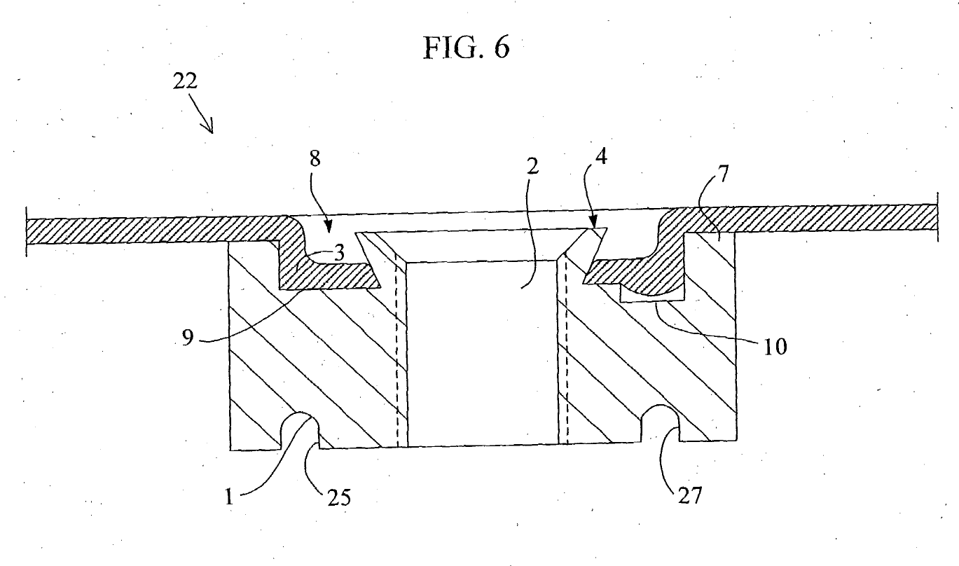

Particularly, the press 20 is adapted to shape the received and straightened wire 16 into a variety of desired and pre-determined shapes, such as, by way of example and without limitation, the shapes which are shown in FIG. 6 and in FIGS. 2-4. It should be realized that substantially any shape may be utilized for the pre-items 22 and that nothing in this description is meant to limit the shape of the entities 22 to one or more predetermined shapes. Rather, the shape which is shown for the entities 22 as illustrated in FIG. 2-4 and 6 is for illustrative purposes only.

Moreover, the press 20 is not only adapted to form the received and relatively straight wire 14 into a desired shape, but also, in some embodiments, to place/form grooves and/or other physical features and characteristics within/upon the produced pre-items 22 in order to allow the formed pre-item 22 to later become properly tapped and/or properly and mutually coupled.

As shown in FIG. 6, one non-limiting example of such a pre-item 22 includes a body 1 which includes or forms a projecting and perforating head 4 which functions as a pilot portion or a punch and which is surrounded by a rim in the form of a continuous skirt 7. The head 4 includes a central pilot hole 2. The body 1 includes a groove 8 and the bottom 9 of the groove 8 has a hollow relief 10 which receives deformed material 3 as this non-limiting example of such a pre-item 22 is selectively inserted into a panel or other tangible item. The pre-item 22 further includes wire or frangible material reception grooves 25, 27 which are respectively adapted to receive wire or some other type of frangible connector material in a manner which is more fully described below. Such items, without grooves 25, 27, are commercially available from The Former Corporation and such items are often referred to as “Press Fix Nuts” and such items are more particularly described with European Patent Number ES2092780T which was published on Dec. 1, 1996 and which is fully and completely incorporated herein by reference, word for word and paragraph for paragraph.

Importantly, while these commercially available entities are available, they have not been efficiently utilized since they are not provided upon a wire or other connecting arrangement in the manner which is shown by the process 10 of FIG. 1 due to the absence of the frangible material reception grooves 25, 27. Nothing in this description is meant to limit the produced pre-item 22 to that which is shown in FIG. 6. Thus, pre-item 22, shown in FIG. 6, may, in one non-limiting embodiment be created by the creation or of grooves 25, 27 within the previously delineated commercially available items (e.g., “Press Fix Nuts”) or the entire pre-item 22 may be formed within press 20.

The system 10 further includes, in one non-limiting embodiment of the invention, an item storage assembly 30 (e.g., a plurality of cooperatively arranged storage bins or containers) which receive the previously formed pre-self-attaching fasteners 22 and which allows them to be temporally stored and then input (e.g., manually or automatically) into an applicator 40 which is also operatively deployed within the system 10. It should be appreciated that substantially and desired type of storage assembly may be utilized, not only storage bins or containers, and that nothing in this description limits the storage facilities to a particular type, shape, and/or geometric orientation. Further, it should be appreciated that the contained items within the storage assembly 30 may be automatically transported from the assembly 30 to the applicator 40, thereby obviating the need for manual insertion/removal.

Alternatively, the use of the storage portion 30 is obviated and the pre-items 22 are directly input into the applicator 40 (e.g., the press 20 automatically (without manual intervention)) communicates with and is directly coupled to the applicator 40 such as by use of a commercially available conveyor. Once (and only after) the pre-items 22 are respectively and completely formed, are they mutually coupled by the use of one or more wires or other type of frangible material. It should be appreciated further that wire 14 may be manually and directly input into the straightener 12 or press 20 or those operations may be accomplished by a conventional transport assembly, such as a motorized assembly which is adapted to attach to the wire 14 and to there after push or pull the wire 14 into the straightener 12 or the press 20 (e.g., a robotic arm type assembly or substantially any other type of motorized assembly).

As shown, the applicator 40 receives wire 42 (or another type of frangible material) and places each of the received and previously formed pre-items 22 upon a portion of the received wire 42 (e.g., the wire 42, in one embodiment, is continually communicated to the applicator 40 as the process proceeds), thereby physically coupling the received pre-items 22 together by use of the received wire 42. A further description of one non-limiting example of an applicator 40 is set forth below. It should be appreciated that other types and configurations of the applicator 40 may be utilized, other than the one which is described below and that wire 42 may actually and alternatively comprise two independently input and separate wires. Further, the wire 42 may be manually fed into the applicator 40 or transported into the applicator 40 by use of a conventional motorized assembly. In another non-limiting embodiment, the wire 42 is manually attached to the received pre-items 22 and the “applicator 40”, within FIG. 1, represents such manual attachment.

Moreover, as is described in greater detail below, each of the pre items 22 may, in one alternate embodiment of the invention, include a central orifice which is to be threaded by a tapper portion, such as tapper 50 which is described below. In another non-limiting embodiment, the tapper portion 50 may be alternatively adapted to both respectively place at least one hole into each of the received pre-items 22 and then thread the respectively and previously created at least one hole. Alternatively, the tapper 50 may be obviated and not used within the system 10.

Thus, in one non-limiting embodiment of the invention, the mutually coupled and previously formed pre-items 22 are then communicated, either manually or by the use of a motorized transport assembly, to a tapper portion 50 which is adapted, in one non-limiting embodiment, to receive and thread the respective and previously formed central pilot hole of each of the coupled items 22 and the “threaded” and * coupled items each comprise a self-attaching fastener which is made in accordance with the teachings of the various inventions. For example, as shown in FIG. 6, this central or pilot hole of the illustrative pre-item 22 is denoted by reference numeral 2 and, in one non-limiting embodiment, this pilot hole 2 is threaded by use of the tapper 50. In another non-limiting embodiment, the pilot hole 2 of the pre-item 22 shown in FIG. 6 is not tapped or threaded by the tapper 50, but rather pre-items 22 are directly communicated from the applicator 40 to the reeler assembly 80. In yet another non-limiting embodiment, the pilot hole 2 is created and threaded by the tapper 50. In yet another non-limiting invention, the central pilot hole 2 is formed/created or tapped before the wire 42 is applied to the created pre-item. Moreover, one non-limiting example of such a motorized transport assembly is assembly 53 which attaches to the wire pair 42 which is connected or placed within the various pre-items 22 emanating from the applicator 40, and pulls the wire pair 42 (and therefore the connected pre-items 22) into the tapper 50 where the creation and/or tapping operation is accomplished, and then pushes the wire pair 42. (and therefore the connected pre-items 22) into the reeler assembly 42.

In this non-limiting embodiment, the coupled and bored and appropriately threaded items 22 (e.g., the produced self-attaching fasteners) are then communicated to a reeler assembly 80 where they are reeled and stored for shipment and later use. Importantly, in order to increase production speed and accuracy, the operation (occurring within the tapper 50) is accomplished only after the pre-items 22 are completely formed and, in one non-limiting embodiment, only after they are mutually coupled.

That is, the tapper assembly 50 includes at least one selectively movable (e.g., reciprocally and selectively movable) head 51 which must be precisely aligned with each of the received and previously coupled pre-items 22 in order to properly thread these pre-items 22 within the respectively formed central bores, such as central bore or hole 2 and/or create at least one hole within the pre-items 22. Thus, each of the produced pre-items 22 must be precisely placed upon a respective known position upon the wire 42 in order to allow the at least one head 51 to be precisely placed at these predetermined and respective central bore locations (e.g., the head 51 is constrained to be operatively and movably moved along directions 55, 57) or at other precisely placed locations.

By placing the pre-items 22 on the wire 42 after the pre-items 22 are completely formed, greater accuracy of placement upon the wire 42 may be achieved because it is known precisely where each pre-item is located with respect to the other pre-items and because the pre-items are mutually coupled, these relative positions are not readily changeable during transport. Knowing the relative and fixed positions of each of the pre-items 22 with respect to the other pre-items 22 allows each of the coupled pre-items 22 to be precisely and easily and automatically placed at respective desired positions within the tapper 50. In one non-limiting embodiment, a sensor or “electric eye” may view each coupled pre-item 22 in order to denote its relative spatial position and communicate this information to the tapper 50 in order to cause the tapper 50 to have the head 51 properly positioned above each received pre-item 22. Thus, this ensures that each respective central bore, such as central bore 2, is properly threaded or created and threaded by the tapper assembly 50 (e.g., is properly placed under the appropriate and desired selectively and reciprocally movable portion 51). Further, because of such enhanced accuracy, a relatively large number of independently moving heads, each being substantially identical to head 51, may be utilized, allowing a relatively large number of fasteners to be produced in a relatively short amount of time (e.g., each such substantially identical head 51 may lie above a unique coupled pre-fastener item “string”). Thus, the overall system 10 is very efficient at producing self-attaching fasteners. It should be appreciated that the term “string” means a collection of mutually coupled pre-items, such as pre-items 22.

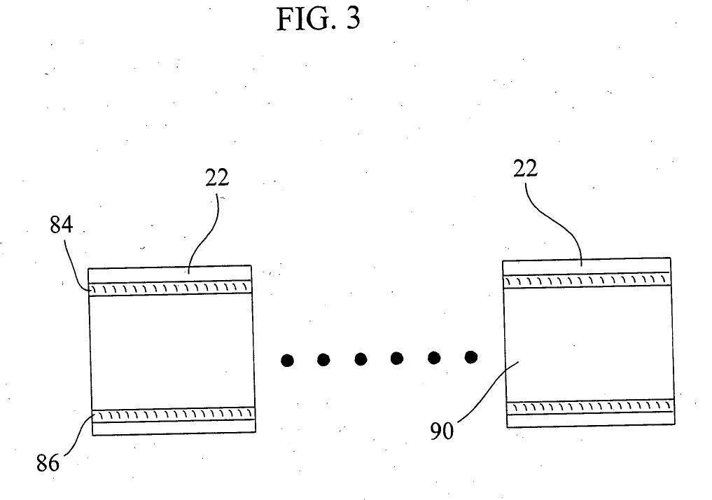

As shown perhaps best in FIG. 3, in one non-limiting embodiment of the invention, each of the produced pre-items 22 includes a pair of substantially identical grooves 84, 86 which are deployed across the length of one respective side 90 of each such produced pre-item 22. In one non-limiting embodiment, side 90 is the side opposite the side that the protrusion or pilot portion, such as pilot portion 91, emanates from. In one non-limiting embodiment, pilot portion 91 is substantially similar to pilot hole 2.

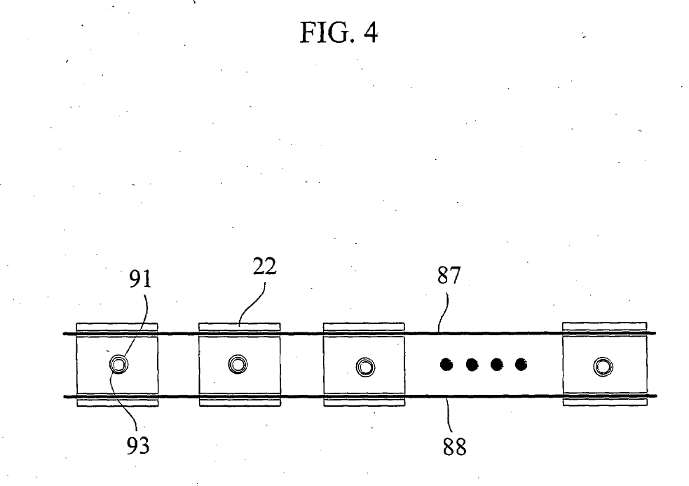

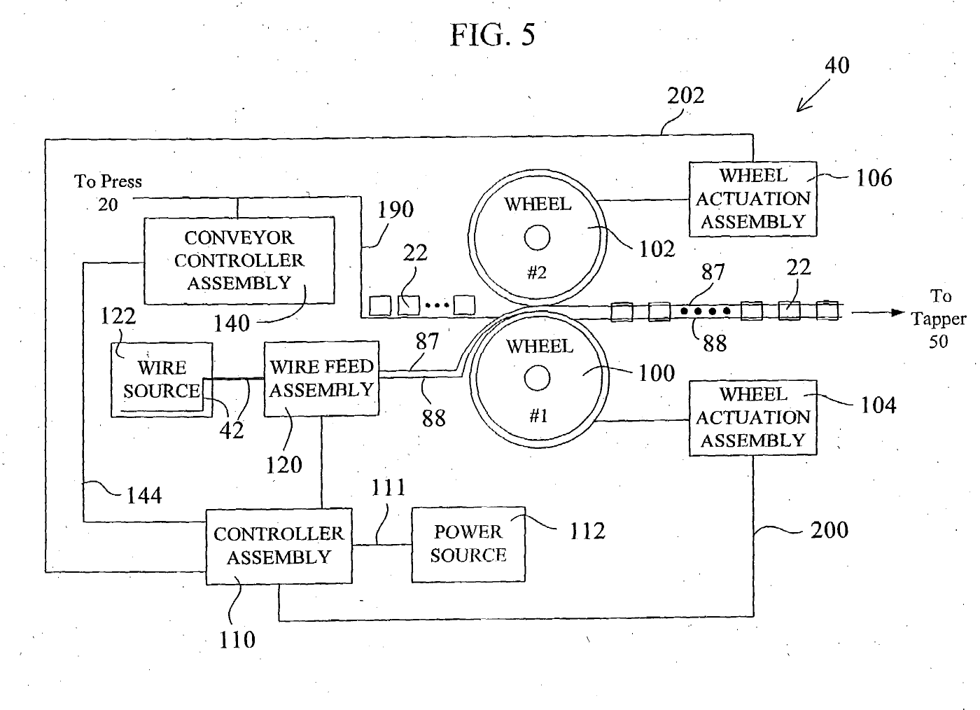

As shown, perhaps best in FIG. 2, wires 87, 88 (e.g., cooperatively denoted as wire 42 in FIG. 1) actually represents/constitutes, in this non-limiting embodiment, a pair of wires 87, 88) and wires 87, 88 are respectively and forcibly placed and therefore made to frictionally reside within the grooves 84, 86, thereby coupling the pre-items 22 together. Moreover, as is shown perhaps best in FIG. 4, the self-attaching fasteners are created by placing a central bore 91 (such as pilot hole 2) in each such pre-item 22 within press 20 and then having threads 93 selectively formed in the respective center bores 91 by the tapper portion 50. To understand the operation of the applicator 40, reference is now made to FIG. 5.

As shown, applicator 40, in one non-limiting embodiment, includes substantially identical wheels 100, 102 and substantially identical wheel actuation assemblies 104, 106 which are respectively coupled to the selectively movable wheels 100, 102. The actuation assemblies 104, 106 are adapted to respectively cause the wheels 100, 102 to selectively and rotatably move or to be selectively stopped or to become stationary.

The applicator 40 further includes a controller assembly 110 which is operable under stored program control and which may comprise, in one non-limiting embodiment of the invention, a personal computer such as that which may be obtained the Dell® corporation of Austin, Tex. or a commercially available programmable logic assembly and which is adapted to be coupled, by the use of bus 111, to a source of electrical power 112. The controller-assembly 110 includes the software/firmware necessary to allow the applicator 40 to perform the desired and described operation.

Further, the applicator 40 includes a wire feed assembly 120 which is coupled to the wire source 122. Particularly, the wire source 122 feeds or communicates wire 42 (e.g., independent wires 87, 88) to the wire feed assembly 120 or the wire feed assembly 120 is adapted to selectively pull the wire 42 from the wire source 122. In one non-limiting embodiment, the wire feed assembly 120 may constitute a robotic arm assembly.

In one non-limiting embodiment of the invention, the applicator 40 further includes a conveyor control assembly 140 which is operable under stored program control and which is controllably and physically coupled to the controller assembly 110 by the use of bus 144 and which is further coupled to a conveyor 190 which is physically coupled to and between the applicator 40 and the press 20 (or between the applicator 40 and the item store portion 30 if such an item store portion 30 is utilized). A portion of the conveyor 190 may also coupled to and between the applicator portion 40 and the tapper 50 and replace the motorized assembly 53. Also, the wheel actuation assemblies 104, 106 are respectively and physically coupled to the controller assembly 110 by use of respective busses 200, 202. The conveyor 190 physically and selectively transports the pre-items 22 to and through the wheels 100, 102 and then to the tapper 50 (or the motorized assembly 53 pushes or pulls the previously coupled pre-items 22 to the tapper 50 in the manner described above).

In operation, the pre-self-attaching fasteners 22 are conveyed, such as by use of the conveyor 190, between the wheels 100, 102 and these wheels 100, 102 cooperatively and forcibly place wires 87, 88 within the respective grooves 84, 86, thereby physically coupling the pre-items 22 in the manner which is shown perhaps best in FIG. 2 (e.g., the wires 87, 88 are respectively and continually placed within the grooves 84, 86) and the speed of the wheels 100, 102 and the speed of the conveyer 190 are configured to allow the wheels 100, 102 to continually force or, in one non-limiting embodiment, “knurl” the wires 87, 88 within the grooves 84, 86 of the received pre-items 22. Therefore, the wires 87, 88 frictionally resides within the respective grooves 84, 86. It should be appreciated that the term “knurling” means to force the wires 87, 88 within the grooves 84, 86 and the applicator 40 may be replaced with a knurling tool or some other sort of manual insertion process.

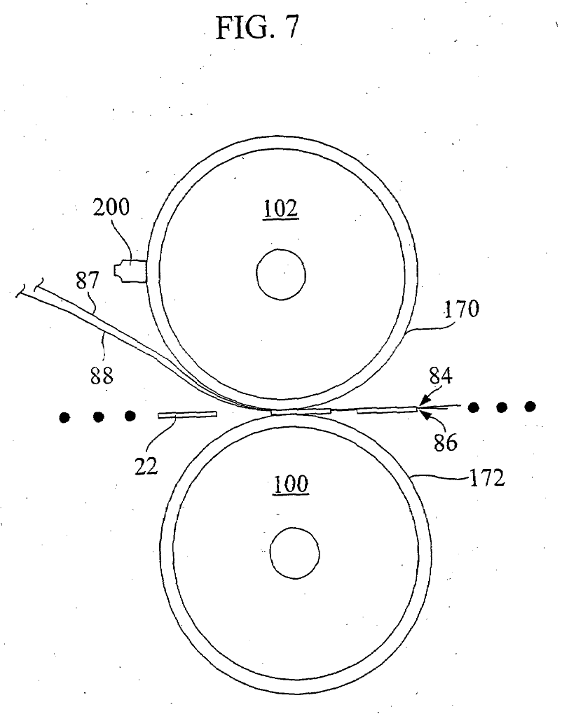

To understand the manner in which the wires 87, 88 may be selectively knurled or forced into the grooves 84, 86, S reference may be had to FIG. 7. Particularly, as shown best in. FIG. 7, the wires 87, 88 are selectively placed along surface 170 of the wheel 102 and as the wheel 102 selectively rotates, the wires 87, 88 are respectively drawn into the grooves 84, 86 of each of the pre-items 22 which come into contact with the surface 170 (e.g., surface 90 of each pre-item 22 contacts wheel 102 on this non-limiting embodiment). The surface 172 of the wheel 100 is principally used to support the various and previously formed pre-items 22 as they receive the wires 87, 88 and to cooperate with the wheel 102 to force the received wires 87, 88 with the respective grooves 84, 86. At least one projection 200 may be provided upon the wheel 102, in an alternate embodiment of the invention, in order to aid the placement of the pre-item 22 between the wheels 100, 102 (e.g., the at least one projection 200 engages a pre-item 22 and forces it into the area between the wheels 100, 102, thereby causing wires 87, 88 to be connected to this engaged pre-item 22). It should be realized that, in an alternate embodiment, the wheel 102 is used to support the received pre-items 22 and surface 90 of each pre-item 22 contacts wheel 100 where the wires 87, 88 are frictionally placed into the-grooves 84, 86.

It is to understood that the inventions are not limited to the exact embodiments which have been described and discussed above, but that various changes and modifications may be made without departing from the spirit and the scope of thee various inventions as is set forth in the following claims. It should be appreciated that only one groove, of the two grooves 84, 86 may be utilized/formed upon the pre-items 22 and that the produced self-attaching fastener may comprise pierce nuts and that the wires 87, 88 may be manually inserted into the respective grooves 84, 86 by a knurling tool or some other similar tool.

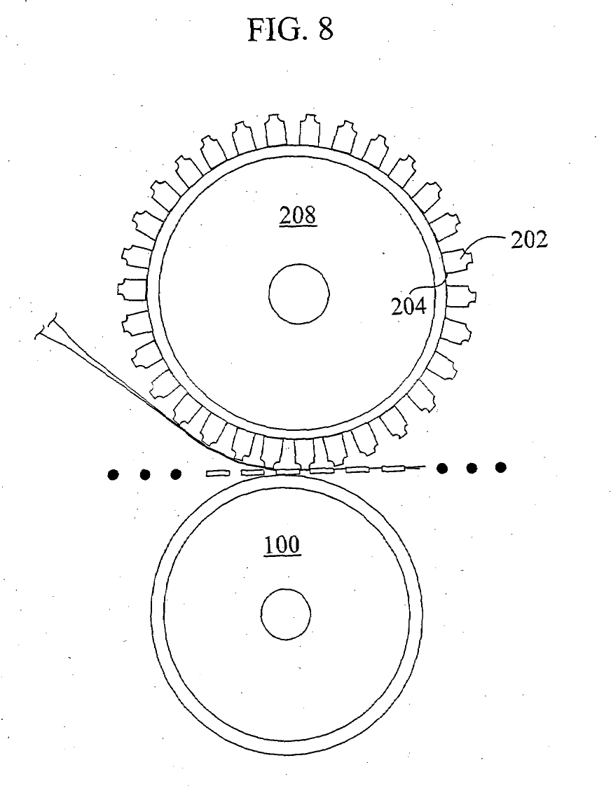

As shown best in FIG. 8, wheel 102 may be replaced by a wheel 208. Particularly, wheel 208 includes a plurality of equally spaced and substantially identical projection portions 202 which are respectively, removably, and frictionally nestled within respective, unique, and substantially identical grooves 204. The removability of the projection portions 202 is particularly important, in this non-limiting embodiment, in order to facilitate efficient maintenance and repair and equally spaced projections 202 function in a substantially similar manner to projections 200. Further, if pre-item 22 is formed, each projection 202 engages pre-item 22 in the respective center or pilot portion, such as pilot portion 2, thereby reducing the likelihood of damage. It should be appreciated that the shape, size, and overall geometric configuration/orientation of the various projection portions 202 may be modified as desired and be adapted to the exact shape which the pre-items 22 are formed. It should also be understood that one or more pre-items 22 may receive wire 42 and one or more pre-items 22 may respectively form a self-attaching fastener.

What is claimed is:

1) A method for producing self-attaching fasteners comprising the steps of obtaining wire; forming the wire into a plurality of discrete items, wherein each of said plurality of discrete items have a predetermined shape and with at least one groove; only after each of said plurality of discrete items have been formed, forcing a wire into each of said at least one grooves of each of said plurality of discrete items, thereby coupling said-previously formed plurality of discrete items; and tapping each of said coupled plurality of discrete items thereby forming self-attaching fasteners.

2) The method of claim 1 wherein said self-attaching fasteners comprise pierce nuts.

3) A self-attaching fasteners forming assembly comprising a straightener which receives and straightens wire; a die which receives said straightened wire from said straightener and which forms said received straightened wire into a plurality of discrete tangible items; a knurling assembly which receives said plurality of previously formed plurality of discrete items and which receives a second wire, wherein said knurling assembly couples each of said previously formed plurality of discrete items onto said second wire; and a tapper assembly which receives said coupled discrete items from said knurling assembly and which produces a threaded hole into each of said received and coupled plurality of discrete items, thereby forming said self-attaching fasteners.

4) A self-attaching fastener formed by the process of obtaining, wire; producing pre-self-attaching fastener; coupling said formed pre-self-attaching fastener item to a wire; and forming a threaded hole within said previously coupled and previously formed pre-self-attaching fastener, thereby forming self-attaching fastener item.

5) The self-attaching fastener of claim 3 wherein said self-attaching fastener comprises a pierce nut.

6) A method for making a self-attaching fastener comprising the steps of obtaining a press fix nut; creating at least one wire retention groove within the obtained press fix nut; placing wire within the created at least one wire retention groove, thereby forming a self-attaching fastener.
